(19) United States
(12) Patent Application Publication
(10) Pub. No.: US 2008/0155627 A1
(43) Pub. Date: Jun. 26, 2008

(54) Systems and methods of searching for and presenting video and audio

(76) Inventors: Daniel O'Connor, Plaistow, NH (US); Mark Pascarella, Andover, MA (US); Patrick Donovan, Westford, MA (US)

Correspondence Address: ROPES & GRAY LLP, PATENT DOCKETING 39/41, ONE INTERNATIONAL PLACE, BOSTON, MA, 02110-2624, US

(21) Appl. No.: 12/001,050

(22) Filed: Dec. 4, 2007

Related U.S. Application Data
(60) Provisional application No. 60/872,736, filed on Dec. 4, 2006.

(51) Int. Cl. H04N 7/173

(52) U.S. Cl. 725/109

(57) ABSTRACT

The invention relates to systems and methods for providing video segments over a network. In one embodiment, metadata identifying a video segment is received from a first client device and transmitted to a second client device on a platform different than the first client device, via a network. In another embodiment, metadata identifies a key frame of a video file, which may be used to retrieve and/or playback a portion of the video file via the network. In another embodiment, metadata, generated at a plurality of client devices that are linked via the network, are indexed.

### CROSS-REFERENCE TO RELATED APPLICATIONS

This application claims the benefit of U.S. Provisional Application No. 60/872,736 filed Dec. 4, 2006, which is hereby incorporated by reference herein in its entirety.

### BACKGROUND

As the popularity of the Internet and mobile devices such as cell phones and media players rises, the ability to easily access, locate, and interact with content available through these entertainment/information portals becomes more important. Current systems for viewing, finding, and editing media content usually require multiple programs that each serve a separate purpose and the ability to download, store, and/or manipulate large media files. For example, video sharing websites like YouTube allow users to upload and tag videos. Other users may search the uploaded video by keyword searching the tags. However, YouTube restricts the size and length of the videos and does not provide the capability for a user to edit videos to conform to these restrictions. In addition, uploading and editing large videos may require significant storage space, bandwidth and/or time. In another example, the Project Runway website on www.bravotv.com allows a user to create playlists from video segments of the Project Runway show to create their own “video mashups.” However, no capability exists to browse through episodes of the show to designate their own video segments for use in a playlist. In addition, many video files are relatively large, which can make downloading and viewing them time-consuming. In cases where only a small portion of a video file is relevant to a user's needs, the ability to search for and view only that portion is desirable. A need remains for a more streamlined, unified system for processing and manipulating media content across multiple platforms.

### SUMMARY

This invention relates to methods and systems for providing video segments over a network. According to one aspect of the invention, a method for providing video segments over a plurality of client devices linked by a network includes the steps of receiving, from a first client device, metadata identifying a video segment, and transmitting the metadata for receipt by a second client device in communication with the first client device via the network. The first client device is on a first platform type and the second client device is on a second platform type different from the first platform type. The metadata identifies a portion of a video file that corresponds to the video segment. The second client device is capable of using the metadata to display the video segment, in response to a request from a user of the second client device. Exemplary first and second platform types include an internet, a mobile device network, a satellite television system, and a cable television system.

The second client device may use the metadata to display the video segment by retrieving the portion of the video file that is identified by the metadata. The metadata may include a location at which the video file is stored, where the second client device retrieves the portion of the video file using the location. In some embodiments, the metadata is stored in a metadata database in communication with each of the first and second client devices via the network. The metadata database may be separate from a video database in which the video file is stored. The metadata may be stored in at least two different formats. In some embodiments, the metadata is stored in a database that is local to the first client device. The second client device may display a mark that indicates to the user that the metadata is available.

The metadata may include a time offset and/or a byte offset to identify the portion of the video file. The metadata may include a start point, an end point, a size, and/or a duration to identify the portion of the video file. The metadata may include a description of contents of the video segment, the description including text and/or a thumbnail image of a frame of the video segment.

In some embodiments, the first client device is displays video files in a first format corresponding to the first client device and the second client device is capable of displaying video files in a second format corresponding to the second client device. Video files in the first format may be converted to video files in the second format.

According to another aspect of the invention, a method for providing video segments over a network includes the steps of receiving a request to retrieve a video segment identified by metadata and, in response to receiving the request, retrieving the portion of the video file, without retrieving other portions of the video file, using the metadata. The metadata identifies a key frame of a video file and a portion of the video file corresponds to the video segment.

In some embodiments, the method includes the step of displaying the video segment using the metadata, where the video file is compressed and displaying the video segment includes using the key frame as an indicator of where to start decoding the portion of the video file. The step of retrieving the portion of the video file may start at a point within the file that is determined based on, at least partially, the key frame. In particular, the step of retrieving the portion of the video file may start at a point within the file corresponding to the key frame or to a first frame of the video segment. The step of retrieving the portion of the video file may use a hypertext transfer protocol. A uniform resource locator may be assigned to the video segment, where the uniform resource locator is unique to the video segment and the request is transmitted via the uniform resource locator.

According to another aspect of the invention, a method for providing video segments over a network includes the steps of receiving information associated with metadata, where the metadata identifies a portion of a video file that corresponds to a video segment and the information is related to contents of the video segment, indexing the information, and storing the indexed information in a first storage device as part of a first metadata index, where the first metadata index is generated by indexing information associated with metadata generated at a plurality of client devices linked via the network.

The metadata may include a location of the video file. The information may include a description of the contents of the video segment, a ranking of the video segment, a rating of the video segment, and/or a user associated with the video segment. A client device may use the metadata to retrieve and display the video segment. The metadata may be generated automatically and/or in response to input from a user at a client device.

In some embodiments, the method includes the steps of receiving a search query, processing the first metadata index, based on the search query, to retrieve a list of at least one video segment having contents related to information that satisfies the search query, and transmitting the list of at least one video segment for receipt by a client device. In some embodiments, the method includes the step of crawling the network to maintain the first metadata index. In some embodiments, the method includes the steps of processing the first metadata index, based on a playlist query, to generate a playlist of video segments having contents related to information that satisfies the playlist query and transmitting, for receipt by a client device, metadata identifying video segments of the playlist, where the client device is capable of using the metadata to display a video segment of the playlist. The client device may use the metadata to display a video segment of the playlist by retrieving a portion of a video file that is identified by the metadata and corresponds to the video segment. In some embodiments, the method includes the step of synchronizing the first metadata index with a second metadata index stored on a second storage device in communication with the first storage device via the network.

### BRIEF DESCRIPTION OF THE DRAWINGS

In the detailed description which follows, reference will be made to the attached drawings, in which:

FIG. 1 depicts an illustrative system capable of providing video to users via multiple platforms;

FIGS. 2A and 2B depict illustrative abstract representations of formats for video and metadata corresponding to the video;

FIG. 3 depicts an illustrative system for sharing video within a community;

FIG. 4 depicts an illustrative screenshot of a user interface for interacting with video; and

FIG. 5 depicts an illustrative abstract representation of a sequence of frames of an encoded video file.

### DETAILED DESCRIPTION

The invention includes methods and systems for searching for and interacting with media over various platforms that may be linked. In one embodiment, a user uses metadata to locate, access, and/or navigate media content. The user may also generate metadata that corresponds to media content. The metadata may be transmitted over various types of networks to share between users, to be made publicly available, and/or to transfer between different types of presentation devices. The following illustrative embodiments describe systems and methods for processing and presenting video content. The inventions disclosed herein may also be used with other types of media content, such as audio or other electronic media.

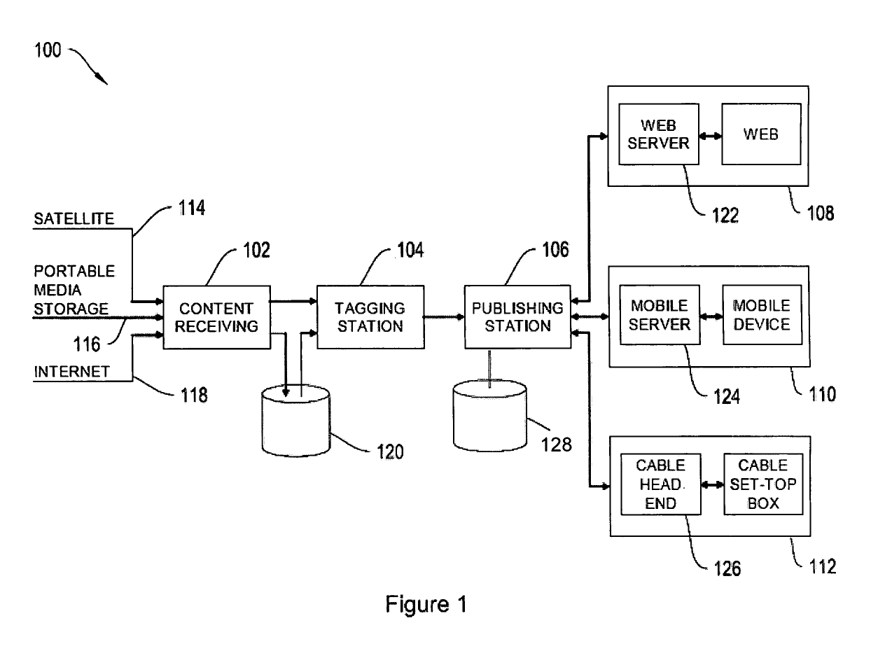

FIG. 1 depicts an illustrative system 100 that is capable of providing video to users via multiple platforms. The system 100 receives video content via a content receiving system 102 that transmits the video content to a tagging station 104 capable of generating metadata that corresponds to the video content to enhance a user's experience of the video content. A publishing station 106 prepares the video content and corresponding metadata for transmission to a platform, where the preparation performed by the publishing station 106 may vary according to the type of platform. FIG. 1 depicts three exemplary types of platforms: the Internet 108, a wireless device 110 and a cable or satellite television system 112.

The content receiving system 102 may receive video content via a variety of methods. For example, video content may be received via satellite 114, imported using some form of portable media storage 116 such as a DVD or CD, or downloaded from or transferred over the Internet 118, for example by using FTP (file transfer protocol). Video content broadcast via satellite 114 may be received by a satellite dish in communication with a satellite receiver or set-top box. A server may track when and from what source video content arrived and where the video content is located in storage. Portable media storage 116 may be acquired from a content provider and inserted into an appropriate playing device to access and store its video content. A user may enter information about each file such as information about its contents. The content receiving system 102 may receive a signal that indicates that a website monitored by the system 100 has been updated In response, the content receiving system 102 may acquire the updated information using FTP.

Video content may include broadcast content, entertainment, news, weather, sports, music, music videos, television shows, and/or movies. Exemplary media formats include MPEG standards, Flash Video, Real Media, Real Audio, Audio Video Interleave, Windows Media Video, Windows Media Audio, Quicktime formats, and any other digital media format. After being receiving by the content receiving system 102, video content may be stored in storage 120, such as Network-Attached Storage (NAS) or directly transmitted to the tagging station 104 without being locally stored. Stored content may be periodically transmitted to the tagging station 104. For example, news content received by the content receiving system 102 may be stored, and every 24 hours the news content that has been received over the past 24 hours may be transferred from storage 120 to the tagging station 104 for processing.

The tagging station 104 processes video to generate metadata that corresponds to the video. The metadata may enhance an end user's experience of video content by describing a video, providing markers or pointers for navigating or identifying points or segments within a video, generating playlists of videos or video segments, or retrieving video. In one embodiment, metadata identifies segments of a video file that may aid a user to locate and/or navigate to a particular segment within the video file. Metadata may include the location and description of the contents of a segment within a video file. The location of a segment may be identified by a start point of the segment and a size of the segment, where the start point may be a byte offset of an electronic file or a time offset from the beginning of the video, and the size may be a length of time or the number of bytes within the segment. In addition, the location of the segment may be identified by an end point of the segment. The contents of the segment may be described through a segment name, a description of the segment, tags such as keywords or short phrases associated with the contents. Metadata may also include information that helps a presentation device decode a compressed video file. For example, metadata may include the location of the I-frames or key frames within a video file necessary to decode the frames of a particular segment for playback. Metadata may also designate a frame that may be used as an image that represents the contents of a segment, for example as a thumbnail image. Metadata may include the location where the video file is stored. The tagging station 104 may also generate playlists of segments that may be transmitted to users for viewing, where the segments may be excerpts from a single received video file, for example highlights of a sports event, or excerpts from multiple received video files. Metadata may be stored as an XML (Extensible Markup Language) file separate from the corresponding video file and/or may be embedded in the video file itself. Metadata may be generated by a user using a software program on a personal computer or automatically by a processor configured to recognize particular segments of video. Exemplary methods for automatic metadata generation include speech-to-text algorithms, facial recognition processes, object or character recognition processes, and semantic analysis processes.

The publishing station 106 processes and prepares the video files and metadata, including any segment identifiers or descriptions, for transmittal to various platforms. Video files may be converted to other formats that may depend on the platform. For example, video files stored in storage 120 or processed by the tagging station 104 may be formatted according to an MPEG standard, such as MPEG-2, which may be compatible with cable television 112. MPEG video may be converted to flash video for transmittal to the Internet 108 or 3GP for transmittal to mobile devices 110.

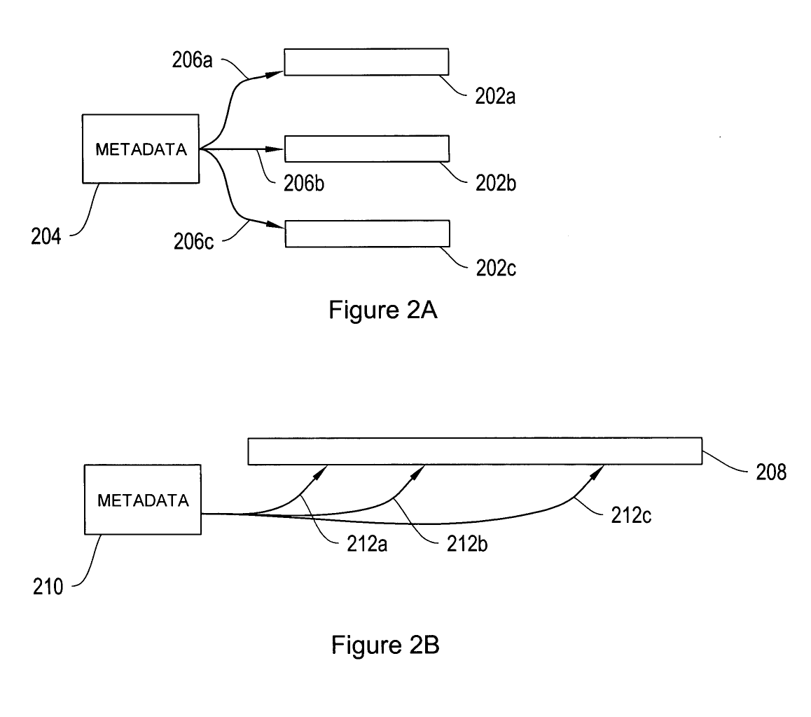

Video files may be converted to multiple video files, each corresponding to a different video segment, or may be merged to form one video file. FIG. 2A depicts an illustrative example of how video and metadata are organized for transmittal to the Internet 108 from the publishing station 106. Video segments are transmitted as separate files 202a, 202b, and 202c, with an accompanying playlist transmitted as metadata 204 that includes pointers 206a, 206b, and 206c to each file containing a segment in the playlist. FIG. 2B depicts an illustrative example of how video and metadata are organized for transmittal to a cable television system 112 from the publishing station 106. Video segments, that may originally have been received from separate files or sources, form one file 208, and are accompanied by a playlist transmitted as metadata 210 that includes pointers 212a, 212b, and 212c to separate points within the file 208 that each represent the start of a segment. The publishing station 106 may also receive video and metadata organized in one form from one of the platforms 108, 110, and 112, for example that depicted in FIG. 2A, and re-organize the received video and metadata into a different form, for example that depicted in FIG. 2B, for transmittal to a different platform. Each type of platform 108, 110, or 112 has a server, namely a web server 122, mobile server 124, or cable head end 126, respectively, that receives video and metadata from the publishing station 106 and can transmit the video and/or metadata to a presentation device in response to a request for the video, a video segment, and/or metadata.

The publishing station 106 may be in communication with storage 128. In particular, the publishing station 106 may store metadata and/or an index of metadata in storage 128, where the metadata may have been generated at the tagging station 104 or at a client device on one of the platforms 108, 110, and 112, where the client device in turn may have access to the metadata and/or metadata index stored in storage 128. In some embodiments, storage 128 is periodically updated across multiple platforms, thereby allowing client devices across multiple platforms to have access to the same set of metadata. Exemplary methods for periodically updating storage 128 include crawling a network of a platform (e.g., web crawling the Internet 108), updating data stored on storage 128 each time metadata is generated or modified at a particular client device or by a particular user, and synchronizing storage 128 with storage located on one of the platforms, (e.g., a database located on the Internet 108, a memory located on a cable box or digital video recorder on the cable television system 112).

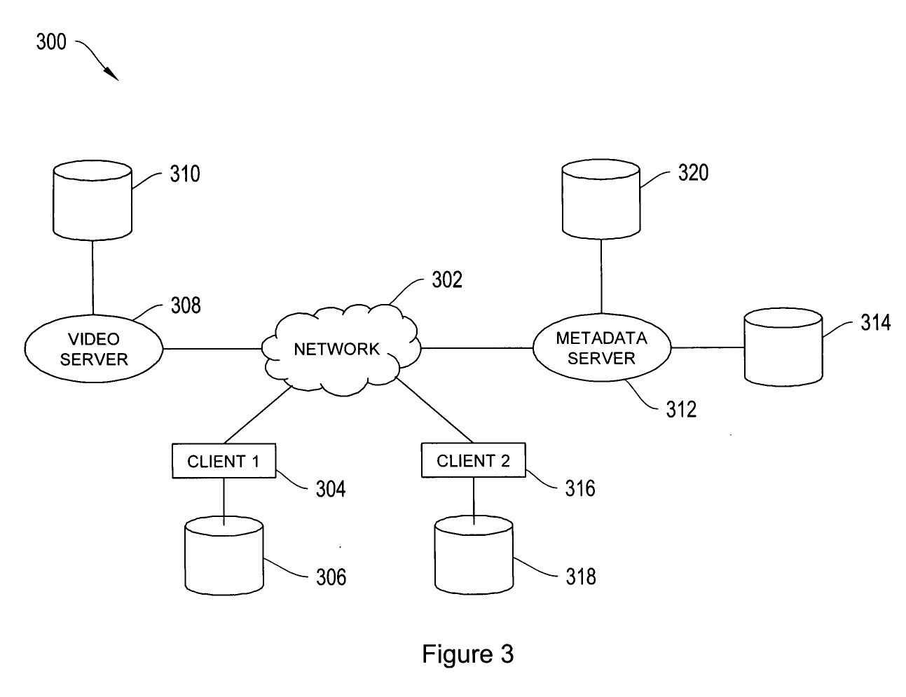

FIG. 3 depicts an illustrative system 300 for sharing video within a community of users over a network 302, such as the Internet. A first user at a first client device 304 and a second user at a second client device 316 may each generate metadata that corresponds to video that is either stored locally in storage 306 and 318, respectively, or available over the network, for example from a video server 308, similar to the web server 122 depicted in FIG. 1, in communication with storage 310 that stores video. Other users, though not depicted, may also be in communication with the network 302 and capable of generating metadata. Metadata generated by users may be made available over the network 302 for use by other users and stored either at a client device, e.g., storage 306 and 318, or in storage 320 in communication with a metadata server 312. In some embodiments, a web crawler automatically browses the network 302 to create and maintain an index 314 of metadata corresponding to video available over the network 302, which may include user-generated metadata and metadata corresponding to video available from the video server 308. Generally, information about metadata, such as descriptions of the metadata content, the source of the metadata, ratings or rankings of the video segment designated by the metadata, and a location where the metadata is stored, may be stored in metadata index 314. The metadata server 312 may receive requests over the network 302 for metadata that is stored at storage 320 and/or indexed by the metadata index 314. In some embodiments, the metadata server 312 may implement a search engine. In particular, the metadata server 312 may receive a search query and process the metadata index 314, based on the search query, to generate a list of video segments, each of which corresponding to metadata that is related to the search query. In some embodiments, the metadata server 312 may automatically generate a playlist of video segments using the metadata index 314. In particular, the metadata server 312 may process the metadata index 314, based on a playlist query, to generate a playlist of video segments, each of which corresponding to metadata that is related to the playlist query. Exemplary playlist queries may request video segments that have contents relating to the same subject matter, are ranked or rated the highest, are the newest or most recently modified, or are generated by the same user. The system 300 may have multiple metadata indices, similar to the metadata index 314 and in communication over the network 302, which are periodically synchronized so that each metadata index is identical to the others. Similarly, the system 300 may have multiple metadata storages, similar to storage 320 and in communication over the network 302, which are periodically synchronized so that each metadata storage is identical to the others.

In one embodiment, metadata is stored in at least two different formats. One format is a relational database, such as an SQL database, to which metadata may be written when generated. The relational database may be include tables organized by user and include, for each user, information such as user contact information, password, and videos tagged by the user and accompanying metadata. Metadata from the relational database may be exported periodically as an XML file to a flat file database, such as an XML file. The flat file database may be read, crawled, searched, indexed, e.g. by an information retrieval application programming interface such as Lucene, or processed by any other appropriate software application (e.g., an RSS feed). For example, the publishing station 106 of FIG. 1 may receive, from the tagging station 104, metadata in a flat file format and convert the metadata to a relational format for indexing and storage in storage 128. The publishing station 106 may also convert the metadata back to a flat file format for transmission to the platforms 108, 110, and 112. Multiple copies of databases may each be stored with corresponding metadata servers, similar to the metadata server 312, at different colocation facilities that are synchronized.

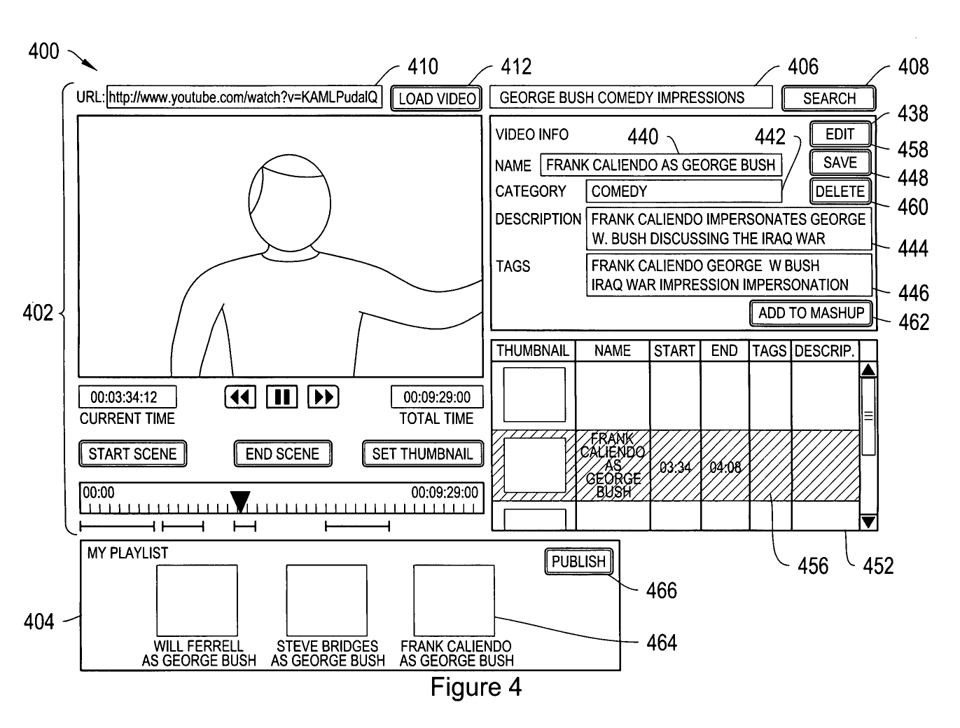

FIG. 4 depicts an illustrative screenshot 400 of a user interface for interacting with video. A tagging station 402 allows a user to generate metadata that designates segments of video available over a network such as the Internet. The user may add segments of video to an asset bucket 404 to form a playlist, where the segments may have been designated by the user and may have originally come from different sources. The user may also search for video and video segments available over the network by entering search terms into a search box 406 and clicking on a search button 408. A search engine uses entered search terms to locate video and video segments that have been indexed by a metadata index, similar to the metadata index 314 depicted in FIG. 3. For example, a user may enter the search terms “George Bush comedy impressions” to locate any video showing impersonations of President George W. Bush. The metadata index may include usernames of users who have generated metadata, allowing other users to search for video associated with a specific user. Playback systems capable of using the metadata generated by the tagging station 402 may be proprietary. Such playback systems and the tagging station 402 may be embedded in webpages, allowing videos to be viewed and modified at webpages other than those of a provider of the tagging station 402.

Using the tagging station 402, a user may enter the location, e.g. the uniform resource locator (URL), of a video into a URL box 410 and click a load video button 412 to retrieve the video for playback in a display area 414. The video may be an externally hosted Flash Video file or other digital media file, such as those available from YouTube, Metacafe, and Google Video. For example, a user may enter the URL for a video available from a video sharing website, such as http://www.youtube.com/watch?v=kAMIPudalQ, to load the video corresponding to that URL. The user may control playback via buttons such as rewind 416, fast forward 418, and play/pause 420 buttons. The point in the video that is currently playing in the display area 414 may be indicated by a pointer 422 within a progress bar 424 marked at equidistant intervals by tick marks 426. The total playing time 428 of the video and the current elapsed time 430 within the video, which corresponds to the location of the pointer 422 within the progress bar 424, may also be displayed.

To generate metadata that designates a segment within the video, a user may click a start scene button 432 when the display area 414 shows the start point of a desired segment and then an end scene button 434 when the display area 414 shows the end point of the desired segment. The metadata generated may then include a pointer to a point in the video file corresponding to the start point of the desired segment and a size of the portion of the video file corresponding to the desired segment. For example, a user viewing a video containing the comedian Frank Caliendo performing a variety of impressions may want to designate a segment of the video in which Frank Caliendo performs an impression of President George W. Bush. While playing the video, the user would click the start scene button 432 at the beginning of the Bush impression and the end scene button 434 at the end of the Bush impression. The metadata could then include either the start time of the desired segment relative to the beginning of the video, e.g., 03:34:12, or the byte offset within the video file that corresponds to the start of the desired segment and a number representing the number of bytes in the desired segment. The location within the video and length of a designated segment may be shown by a segment bar 436 placed relative to the progress bar 424 such that its endpoints align with the start and end points of the designated segment.

To generate metadata that describes a designated segment of the video, a user may enter into a video information area 438 information about the video segment such as a name 440 of the video segment, a category 442 that the video segment belongs to, a description 444 of the contents of the video segment, and tags 446, or key words or phrases, related to the contents of the video segment. To continue with the example above, the user could name the designated segment “Frank Caliendo as Pres. Bush” in the name box 440, assign it to the category “Comedy” in the category box 442, describe it as “Frank Caliendo impersonates President George W. Bush discussing the Iraq War” in the description box 444, and designate a set of tags 446 such as “Frank Caliendo George W Bush Iraq War impression impersonation.” A search engine may index the video segment according to any text entered in the video information area 438 and which field, e.g. name 440 or category 442, the text is associated with. A frame within the segment may be designated as representative of the contents of the segment by clicking a set thumbnail button 450 when the display area 414 shows the representative frame. A reduced-size version of the representative frame, e.g. a thumbnail image such as a 140×100 pixel JPEG file, may then be saved as part of the metadata.

When finished with entering information, the user may click on a save button 448 to save the metadata generated, without necessarily saving a copy of the video or video segment. Metadata allows a user to save, upload, download, and/or transmit video segments by generating pointers to and information about the video file, and without having to transmit the video file itself. As generally metadata files are much smaller than video files, metadata can be transmitted much faster and use much less storage space than the corresponding video. The newly saved metadata may appear in a segment table 452 that lists information about designated segments, including a thumbnail image 454 of the representative frames designated using the set thumbnail button 450. A user may highlight one of the segments in the segment table 452 with a highlight bar 456 by clicking on it, which may also load the highlighted segment into the tagging station 402. If the user would like to change any of the metadata for the highlighted segment, including its start or end points or any descriptive information, the user may click on an edit button 458. The user may also delete the highlighted segment by clicking on a delete button 460. The user may also add the highlighted segment to a playlist by clicking on an add to mash-up button 462 which adds the thumbnail corresponding to the highlighted segment 464 to the asset bucket 404. To continue with the example above, the user may want to create a playlist of different comedians performing impressions of President George W. Bush. When finished adding segments to a playlist, the user may click on a publish button 466 that will generate a video file containing all the segments of the playlist in the order indicated by the user. In addition, clicking the publish button 466 may open a video editing program that allows the user to add video effects to the video file, such as types of scene changes between segments and opening or closing segments.

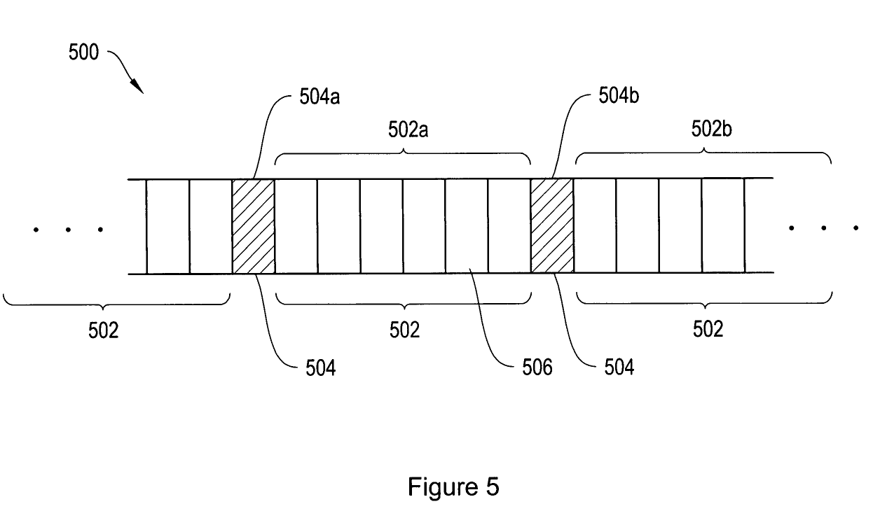

Metadata generated and saved by the user may be transmitted to or available to other users over the network and may be indexed by the metadata index of the search engine corresponding to the search button 408. When another user views or receives metadata and indicates a desire to watch the segment corresponding to the viewed metadata, a playback system for the other user may retrieve just that portion of a video file necessary for the display of the segment corresponding to the viewed metadata. For example, the hypertext transfer protocol (http) for the Internet is capable of transmitting a portion of a file as opposed to the entire file. Downloading just a portion of a video file decreases the amount of time a user must wait for the playback to begin. In cases where the video file is compressed, the playback system may locate the key frame (or I-frame or intraframe) necessary for decoding the start point of the segment and download the portion of the video file starting either at that key frame or the earliest frame of the segment, whichever is earlier in the video file. FIG. 5 depicts an illustrative abstract representation 500 of a sequence of frames of an encoded video file. In one embodiment, the video file is compressed such that each non-key frame 502 relies on the nearest key frame 504 that precedes it. In particular, non-key frames 502a depend on key frame 504a and similarly non-key frames 502b depend on key frame 504b. To decode a segment that starts at frame 506, for example, a playback system would download a portion of the video file starting at key frame 504a. The location of the necessary key frames and/or the point in a video file at which to start downloading may be saved as part of the metadata corresponding to a video segment. In some embodiments, a uniform resource locator may be assigned to, and be unique to, the video segment corresponding to a portion of a video file. Entry of the uniform resource locator into a web browser may cause the web browser to retrieve just the portion of the video file for playback on the client device implementing the web browser.

The user may also during playback of a video or video segment mark a point in the video and send the marked point to a second user so that the second user may view the video beginning at the marked point. Metadata representing a marked point may include the location of the video file and a pointer to the marked point, e.g. a time offset relative to the beginning of the video or a byte offset within the video file. The marked point, or any other metadata, may be received on a device of a different platform than that of the first user. For example, with reference to FIG. 1, the first user may mark a point in a video playing on a computer connected to the Internet, such as the Internet 108, then transmit the marked point via the publishing station 106 to a friend who receives and plays back the video, starting at the marked point, on a mobile phone, such as the wireless device 110. Marked points or other metadata may also be sent between devices belonging to the same user. For example, a user may designate segments and create playlists on a computer connected to the Internet, to take advantage of the user interface offered by such a device, and send playlists and marked points indicating where the user left off watching a video to a mobile device, which is generally more portable than a computer.

In general, a device on a platform 108, 110 or 112 depicted in FIG. 1 may be in communication with a network similar to the network 302 depicted in FIG. 2 to allow users in communication with the network 302 access to video and metadata generated by the system 100 of FIG. 1 and to transmit video and metadata across platforms. The user interface depicted in FIG. 4 may be used on any of the platforms 108, 110, and 112 of FIG. 1. In addition, simplified versions of the user interface, for example a user interface that allows only playback and navigation of playlists or marked points, may be used on platforms having either a small display area, e.g. a portable media player or mobile phone, or tools for interacting with the user interface with relatively limited capabilities, e.g., a television remote. The systems and methods disclosed herein are representative embodiments, and may be applied to the audio content, files, and segments, as well, including but not limited to, terrestrial, digital, satellite and HD radio, personal audio devices, and MP3 players.

Applicants consider all operable combinations of the embodiments disclosed herein to be patentable subject matter.

What is claimed is:

1. A method for providing video segments over a plurality of client devices linked by a network, comprising
receiving, from a first client device, metadata identifying a video segment, wherein
the first client device is on a first platform type, and
the metadata identifies a portion of a video file that corresponds to the video segment, and
transmitting the metadata for receipt by a second client device in communication with the first client device via the network, wherein
the second client device is on a second platform type different from the first platform type, and
the second client device is capable of using the metadata to display the video segment, in response to a request from a user of the second client device.

2. The method of claim 1, wherein each of the first and second platform types comprises at least one of an internet, a mobile device network, a satellite television system, and a cable television system.

3. The method of claim 1, wherein the second client device is capable of using the metadata to display the video segment by retrieving the portion of the video file that is identified by the metadata.

4. The method of claim 1, wherein
the metadata comprises a location at which the video file is stored, and
the second client device retrieves the portion of the video file using the location.

5. The method of claim 1, wherein the metadata is stored in a metadata database in communication with each of the first and second client devices via the network.

6. The method of claim 5, wherein the metadata database is separate from a video database in which the video file is stored.

7. The method of claim 5, wherein the metadata is stored in at least two different formats.

8. The method of claim 1, wherein the metadata is stored in a database that is local to the first client device.

9. The method of claim 1, wherein the metadata comprises at least one of a time offset and a byte offset to identify the portion of the video file.

10. The method of claim 1, wherein the metadata comprises at least one of a start point, an end point, a size, and a duration to identify the portion of the video file.

11. The method of claim 1, wherein the first client device is capable of displaying video files in a first format corresponding to the first client device and the second client device is capable of displaying video files in a second format corresponding to the second client device.

12. The method of claim 11, comprising converting video files in the first format to video files in the second format.

13. The method of claim 1, wherein the metadata comprises a description of contents of the video segment, the description comprising at least one of text and a thumbnail image of a frame of the video segment.

14. The method of claim 1, wherein the second client device displays a mark that indicates to the user that the metadata is available.

15. A method for providing video segments over a network, comprising
receiving a request to retrieve a video segment identified by metadata, wherein
the metadata identifies a key frame of a video file, and
a portion of the video file corresponds to the video segment, and
in response to receiving the request, retrieving the portion of the video file, without retrieving other portions of the video file, using the metadata.

16. The method of claim 15, comprising displaying the video segment using the metadata, wherein
the video file is compressed, and
the displaying the video segment comprises using the key frame as an indicator of where to start decoding the portion of the video file.

17. The method of claim 15, wherein the retrieving the portion of the video file starts at a point within the file that is determined based on, at least partially, the key frame.

18. The method of claim 17, wherein the retrieving the portion of the video file starts at a point within the file corresponding to the key frame.

19. The method of claim 17, wherein the retrieving the portion of the video file starts at a point within the file corresponding to a first frame of the video segment.

20. The method of claim 15, wherein the retrieving the portion of the video file uses a hypertext transfer protocol.

21. The method of claim 15, comprising assigning a uniform resource locator to the video segment, wherein the uniform resource locator is unique to the video segment and the request is transmitted via the uniform resource locator.

22. A method for providing video segments over a network, comprising
receiving information associated with metadata, wherein the metadata identifies a portion of a video file that corresponds to a video segment and the information is related to contents of the video segment,
indexing the information, and
storing the indexed information in a first storage device as part of a first metadata index, wherein the first metadata index is generated by indexing information associated with metadata generated at a plurality of client devices linked via the network.

23. The method of claim 22, comprising
receiving a search query,
processing the first metadata index, based on the search query, to retrieve a list of at least one video segment having contents related to information that satisfies the search query, and
transmitting the list of at least one video segment for receipt by a client device.

24. The method of claim 22, comprising crawling the network to maintain the first metadata index.

25. The method of claim 22, wherein the metadata comprises a location of the video file.

26. The method of claim 22, comprising
processing the first metadata index, based on a playlist query, to generate a playlist of video segments having contents related to information that satisfies the playlist query, and
transmitting, for receipt by a client device, metadata identifying video segments of the playlist, wherein the client device is capable of using the metadata to display a video segment of the playlist.

27. The method of claim 26, wherein the client device is capable of using the metadata to display a video segment of the playlist by retrieving a portion of a video file that is identified by the metadata and corresponds to the video segment.

28. The method of claim 22, wherein the information comprises at least one of a description of the contents of the video segment, a ranking of the video segment, a rating of the video segment, and a user associated with the video segment.

29. The method of claim 22, comprising synchronizing the first metadata index with a second metadata index stored on a second storage device in communication with the first storage device via the network.

30. The method of claim 22, wherein a client device is capable of using the metadata to retrieve and display the video segment.

31. The method of claim 22, wherein the metadata is generated automatically.

32. The method of claim 22, wherein the metadata is generated in response to input from a user at a client device.
